(19) United States
(12) Patent Application Publication
(10) Pub. No.: US 2006/0080576 A1
(43) Pub. Date: Apr. 13, 2006

(54) Test point insertion method

(75) Inventor: Yoko Hirano, Kyoto (JP)

Correspondence Address: MCDERMOTT WILL & EMERY LLP, 600 13TH STREET, N.W., WASHINGTON, DC, 20005-3096, US

(73) Assignee: MATSUSHITA ELECTRIC INDUSTRIAL CO., LTD

(21) Appl. No.: 11/226,466

(22) Filed: Sep. 15, 2005

(30) Foreign Application Priority Data
Sep. 17, 2004 (JP) 2004-271969

(51) Int. Cl. G06F 11/00

(52) U.S. Cl. 714/25

(57) ABSTRACT

A method for inserting a test point to enable fault detection comprises the steps of: (a) determining whether or not a value-fixed node needs value fixation; (b) determining that an observation test point is to be inserted to a node which is disabled by the node determined to need value fixation; (c) comparing a test efficiency achieved when a control test point is inserted to the node which is determined to need no value fixation and a test efficiency achieved when an observation test point is inserted to a node which is disabled by the node determined to need no value fixation; and (d) selecting one of the control test point and the observation test point which achieves the higher test efficiency based on the comparison result and determining a node to which the selected test point is to be inserted.

### CROSS-REFERENCE TO RELATED APPLICATION

This application claims priority under 35 U.S.C. § 119(a) on Japanese Patent Application No. 2004-271969 filed on Sep. 17, 2004, the entire contents of which are hereby incorporated by reference.

### BACKGROUND OF THE INVENTION

The present invention relates to a test point insertion method with which fault detection is enabled in the scan design of a semiconductor integrated circuit.

In the scan design of a semiconductor integrated circuit, if the fault detection rate has not reached a target value of the fault detection rate, in order to enable fault detection of an unchecked node, the technique of inserting a test circuit called a “test point” to the unchecked node is used to improve the fault detection rate. In this scan design, after a node to which a test point is to be inserted is determined, the test point is inserted to the determined node.

A conventionally-known scan design method is a scan design method wherein a scan circuit is inserted to a necessary line to suppress a redundant number of gates and an increase in delay. In the scan design method, the capability of confirming whether or not an input or output terminal of each circuit has a fault, i.e., confirmability, and the capability of inputting a predetermined signal at an input terminal of each circuit, i.e., controllability, are calculated. Based on the calculation results, lines are sorted in ascending order of confirmability or controllability, and scan circuits are inserted to the lines sequentially from a line of the worst confirmability or worst controllability (see, for example, Japanese Laid-Open Patent Publication No. 63-134970).

In another conventionally-known scan design method, the testability of a near-acyclic circuit is improved by adding a test point. This method includes the step of calculating the controllability, observability, and fault detection rate of each node after a circuit is divided into a self-loop flip flop and a primary output block, the step of selecting a fault at a specific node and, if the calculated values of controllability, observability, and fault detection rate are not within prescribed ranges, the step of adding a flip flop as a test point (see, for example, Japanese Laid-Open Patent Publication No. 6-331709).

However, in the scan test method disclosed in Japanese Laid-Open Patent Publication No. 63-134970, it is not considered whether the test efficiency is more improved by inserting an observation test point as a scan circuit or by inserting a control test point as a scan circuit in order to improve the confirmability as to the presence/absence of fault detection at any single point.

FIG. 1 is a circuit diagram of a semiconductor integrated circuit. In a group of combinational circuits shown in FIG. 1, a selector sel1 has a control node n2, input nodes n14 and n15, and an output node n16. The control node n2 is connected to an output node n1 of a combinational circuit cc1 and an input node n3 of a buffer. The input node n15 is connected to an output node n13 of a combinational circuit cc4. An OR circuit or1 has input nodes n7 and n8, and an output node n11. The input node n7 is connected to an output node n4 of the buffer. The input node n8 is connected to an output node n5 of a combinational circuit cc2. An OR circuit or2 has input nodes n9 and n10, and an output node n12. The input node n9 is connected to the output node n4 of the buffer. The input node n10 is connected to an output node n6 of a combinational circuit cc3.

In this combinational circuit group, it is assumed that the value of the node n1 is fixed in order to fix the node n2 in scan test, and the values of nodes n3, n4, n7 and n9, which are the branch ends of the node n1, are fixed as a result of propagation of the fixed value of the node n1. In the present state of art, the step of checking a node whose value is fixed during the scan mode operation is not provided. Therefore, an unnecessarily value-fixed node cannot be checked. Due to this wrong value fixation, the states of the combinational circuits cc2 and cc3 cannot be observed, and the fault detection rate decreases.

In this case, to make the states of the combinational circuits cc2 and cc3 observable, observation test points are inserted to be connected to the output nodes n5 and n6. Meanwhile, if a control test point is inserted to be connected to the node n3, faults included in the combinational circuits cc2 and cc3 other than stuck-at-0 faults and stuck-at-1 faults, i.e., a stuck-at-0 fault at the node n3, a stuck-at-0 fault at the node n4, a stuck-at-0 fault at the node n7, and a stuck-at-0 fault at the node n9 are also detectable. Thus, the fault detection rate is improved while the area of added test circuits is decreased.

In the method disclosed in Japanese Laid-Open Patent Publication No. 6-331709 wherein the testability of a near-acyclic circuit is improved by adding a test point, there is a possibility that an increase in the circuit area or timing violation during normal operation is caused due to insertion of a test point.

FIG. 2 is a circuit diagram of another semiconductor integrated circuit. In a group of combinational circuits shown in FIG. 2, an OR circuit or3 has an output node n4, an input node n2 which is connected to an output node n5 of a combinational circuit cc2, and an input node n3 which is connected to an output node n1 of a combinational circuit cc1. In scan test, the output node n5 is fixed to 1 according to a scan mode signal, and the values of nodes n2 and n4 are also fixed as a result of propagation of the fixed value of the node n5. Therefore, the state of the combinational circuit cc1 is not observable, and the fault detection rate decreases.

In such a case, a countermeasure for improving the fault detection rate is insertion of an observation test point tp1 as a test circuit to be connected to the output node n1 such that the state of the combinational circuit cc1 is observable. It should be noted that, in general, the observation test point is inserted to be connected to the final output node of an unobservable combinational circuit group such that the value of the final output node is observable. Alternatively, as shown in FIG. 4, an AND circuit and1, which is a test circuit, and a control test point tp2 are inserted to be connected to the output node n5, such that the input node n2 is 0/1-controllable, i.e., controllable between 0 and 1, in scan test. In this process, the circuit design is such that the output of the control test point tp2 is always 1 during normal operation for the purpose of avoiding affecting the circuit in normal operation.

In the above method for inserting observation test points and control test points, there is a possibility that the fault detection rate per unit area of a test circuit decreases as well as an increase in the area of the test circuit due to an increased number of logic circuits and flip flops added as test points. Further, there is a possibility that the interconnect capacitance is decreased due to node branching or that the cell delay increases due to insertion of a logic circuit. In such a case, the delay over the entire path including a node to which a test point is inserted increases to cause timing violation.

### SUMMARY OF THE INVENTION

An objective of the present invention is to provide a test point insertion method with which the fault detection rate per unit area of a test circuit is improved. Another objective of the present invention is to provide a test point insertion method with which timing damage to a circuit during normal operation is alleviated.

According to the first aspect of the present invention, there is provided a method for inserting a test point to enable fault detection in a circuit which is disabled by propagation of a fixed value of a scan mode signal in scan design of a semiconductor integrated circuit, the method comprising the steps of: (a) determining whether or not a value-fixed node needs value fixation; (b) determining that an observation test point is to be inserted to a node which is disabled by the node determined to need value fixation at step (a), the observation test point allowing the disabled node to be observable; (c) comparing a test efficiency achieved when a control test point is inserted to the node which is determined to need no value fixation at step (a) to allow the node to be controllable and a test efficiency achieved when an observation test point is inserted to a node which is disabled by the node determined to need no value fixation at step (a) to allow the disabled node to be observable; (d) selecting one of the control test point and the observation test point which achieves the higher test efficiency based on the comparison result of step (c) and determining a node to which the selected test point is to be inserted; and (e) inserting the selected test point to the node determined at step (d), wherein the processes from step (a) to step (d) are repeatedly performed on nodes till the fault detection rate reaches a target value and, if the fault detection rate reaches the target value, the process of step (e) is performed.

In the above method, the test efficiency achieved when a control test point is inserted to a node which is determined to need no value fixation and the test efficiency achieved when an observation test point is inserted to a node which is disabled by the node determined to need no value fixation are compared, and one of the test points which achieves the higher test efficiency is selected. Therefore, the number of test points inserted to nodes is decreased, whereby the area of a test circuit is reduced. Thus, the fault detection rate per unit area of the test circuit is improved. The test efficiency can be expressed by, for example, the fault detection rate per unit area of a test circuit which is inserted to a node.

In the above test point insertion method, step (a) preferably includes determining whether or not a value-fixed node needs value fixation according to scan test node fixation information which is information about a node needing value fixation in scan test.

With the above feature, at step (a), a node included in the scan test node fixation information is determined to be a node whose value needs to be fixed in scan test.

Preferably, the above test point insertion method further comprises: the step of obtaining a result of propagation of a fixed value based on information about an input terminal whose value is fixed in scan test; the step of determining, based on information about a node which necessarily needs to be fixed in scan test, a node included in an input cone of the necessarily-fixed node; and the step of selecting, based on the result of propagation of a fixed value, information about the node included in the input cone as the scan test node fixation information.

With the above features, the scan test node fixation information is obtained.

In the above test point insertion method, step (a) preferably includes: determining, based on information about a node which necessarily needs to be fixed in scan test, a node included in an input cone of the necessarily-fixed node; if the value-fixed node is included in the input cone, determining that the value-fixed node needs value fixation; and if the value-fixed node is not included in the input cone, determining that the value-fixed node does not need value fixation.

With the above features, it is determined whether or not the value of a node needs to be fixed based on information about a node which necessarily needs to be fixed in scan test.

According to the second aspect of the present invention, there is provided a test point insertion method, comprising the steps of: (a) inserting a test point to enable fault detection in a circuit which is disabled by propagation of a fixed value of a scan mode signal in scan design of a semiconductor integrated circuit; (b) placing cells after step (a); and (c) consolidating consolidatable test points after step (b).

In the above method, consolidatable test points are consolidated while confirming the placement of cells, such that the congestion degree is relaxed in wired areas. Further, the length of lines is decreased as compared with a conventional layout so that the wired areas are reduced. The interconnect capacitance is suppressed, and timing damage to a circuit during normal operation is alleviated.

In the above test point insertion method, preferably, a test point consolidation condition that test points are determined to be consolidatable if a linear distance between nodes to which the test points are inserted is equal to or shorter than a designated distance is established; and step (c) includes determining whether or not test points are consolidatable based on the test point consolidation condition.

With the above features, at step (c), test points are determined to meet the consolidation condition if a linear distance between nodes to which the test points are inserted is equal to or shorter than a designated distance, and then, consolidation of the test points is carried out.

In the above test point insertion method, preferably, a test point consolidation condition that test points are determined to be consolidatable if a Manhattan distance between nodes to which the test points are inserted is equal to or shorter than a designated distance is established; and step (c) includes determining whether or not test points are consolidatable based on the test point consolidation condition.

With the above features, at step (c), test points are determined to meet the consolidation condition if a Manhattan distance between nodes to which the test points are inserted is equal to or shorter than a designated distance, and then, consolidation of the test points is carried out. Herein, the Manhattan distance is the sum of the absolute values of differences in the values of coordinates between nodes.

In the above test point insertion method, preferably, a test point consolidation condition that test points are determined to be consolidatable if a routing congestion degree between nodes to which the test points are inserted is equal to or lower than a designated routing congestion degree is established; and step (c) includes determining whether or not test points are consolidatable based on the test point consolidation condition.

With the above features, at step (c), test points are determined to meet the consolidation condition if a routing congestion degree between nodes to which the test points are inserted is equal to or lower than a designated routing congestion degree, and then, consolidation of the test points is carried out. Herein, the routing congestion degree is expressed by the ratio of the number of actual lines to the maximum number of lines within a unit area. Specifically, the routing congestion degree increases as the number of lines within a unit area increases, whereas the routing congestion degree decreases as the number of lines within a unit area decreases.

Preferably, the designated routing congestion degree is determined according to the number of lines within a unit area which are used for routing estimation in cell placement.

With the above feature, the designated routing congestion degree is expressed by the number of lines within a unit area.

According to the third aspect of the present invention, there is provided a test point insertion method, comprising the steps of: (a) determining a node for insertion of a test point which enables fault detection in a circuit disabled by propagation of a fixed value of a scan mode signal in scan design of a semiconductor integrated circuit; (b) placing cells after step (a); (c) placing test points in a distributed fashion in an area where a congestion degree of the cells placed at step (b) and lines is lower than a predetermined reference value; and (d) connecting the node determined for test point insertion at step (a) and the test point placed at step (c).

In the above method, a node to which a test point is to be inserted is determined at step (a); cells are placed at step (b); and then test points are placed in a distributed fashion at step (c). Herein, placing test points “in a distributed fashion” means placing test points in an area of low congestion degree, while confirming the congestion degree of previously-placed cells and lines, such that the test points are placed as near as possible to the nodes to which the test points are inserted without making a concentration thereof. Therefore, the test points are inserted to the nodes without substantially affecting the circuit in normal operation, and timing violation which can be caused due to test point insertion is reduced.

In the above test point insertion method, preferably, information about the node determined for test point insertion is output at step (a); critical path information is output at step (b); and step (d), the node and the test point are connected based on the information about the node determined for test point insertion and the critical path information.

With the above features, since the critical path information is used, insertion of a test point to a critical path in placement and synthesis is avoided, and accordingly, timing designing is effectively carried out.

According to the fourth aspect of the present invention, there is provided a test point insertion method, comprising the steps of: (a) determining a node for insertion of a test point which enables fault detection in a circuit disabled by propagation of a fixed value of a scan mode signal in scan design of a semiconductor integrated circuit, the determined node including a node to which a control test point is to be inserted; (b) inserting, to the node to which a control test point is to be inserted, a logic circuit which is necessary for insertion of a control test point; (c) placing cells after step (b); (d) placing test points in a distributed fashion in an area where a congestion degree of the cells placed at step (c) and lines is lower than a predetermined reference value; and (e) connecting the control test point placed at step (d) to a terminal of the logic circuit inserted at step (b).

In the above method, at step (b) before the cell placement step, a logic circuit which is necessary for insertion of a control test point is inserted to the node to which the control test point is to be inserted. With insertion of the logic circuit which is necessary for insertion of a control test point before the cell placement step, timing designing is effectively carried out.

In the above test point insertion method, preferably, step (a) includes outputting information about the node determined for test point insertion; step (c) includes outputting critical path information; and step (e) includes connecting the node and the test point based on the information about the node determined for test point insertion and the critical path information.

With the above features, since the critical path information is used, insertion of a test point to a critical path in placement and synthesis is avoided, and accordingly, timing designing is effectively carried out.

According to the fifth aspect of the present invention, there is provided a test point insertion method, comprising the steps of: (a) inserting a test point to enable fault detection in a circuit which is disabled by propagation of a fixed value of a scan mode signal in scan design of a semiconductor integrated circuit; (b) placing cells after step (a); and (c) if necessity of changing circuit specifications or modifying the circuit occurs after step (b), modifying the circuit using a test point as a repair cell.

In the above method, a test point provided for improving the fault detection rate is used for modification of a circuit. Therefore, it is not necessary to provide a register in a cell called a repair cell, which does not have connection information. Accordingly, the area of the test circuit is further reduced.

In the above test point insertion method, preferably, step (a) includes outputting information about the test point inserted to the node as additional register information; step (b) includes adding coordinate information of the test point to the additional register information; and step (c) includes modifying the circuit based on the additional register information.

With the above features, a test point is used for modification of a circuit using the coordinate information of the test point.

Preferably, a restriction requiring that, among a control test point and an observation test point, only the control test point is usable as a repair cell is placed; and step (c) includes modifying the circuit based on the restriction and the additional register information.

With the above features, only a control test point is usable as a repair cell. Therefore, the fault detection rate is improved as compared with a case where an observation test point is used as a repair cell.

According to a test point insertion method of the present invention, the number of test points inserted to nodes is decreased, whereby the area of a test circuit is reduced, and the fault detection rate per unit area of the test circuit is improved. Further, consolidatable test points are consolidated based on the test point consolidation condition, whereby the congestion degree of the wired area is relaxed. Furthermore, the length of lines is decreased so that the wired area is reduced. The interconnect capacitance is suppressed, and timing damage to a circuit during normal operation is alleviated.

### BRIEF DESCRIPTION OF THE DRAWINGS

FIG. 1 is a circuit diagram of a semiconductor integrated circuit which is subjected to a test point insertion method according to embodiment 1 of the present invention.

FIG. 2 is a circuit diagram including a value-fixed node in a semiconductor integrated circuit.

FIG. 3 illustrates insertion of an observation test point in the semiconductor integrated circuit of FIG. 2.

FIG. 4 illustrates insertion of a control test point in the semiconductor integrated circuit of FIG. 2.

FIG. 5 is a flowchart illustrating a scan design procedure according to embodiment 1.

FIG. 6 is a circuit diagram showing a circuit obtained by modifying the circuit of FIG. 1.

FIG. 7 is a flowchart illustrating a process of generating scan test node fixation information.

FIG. 8 is a flowchart illustrating a variation of the process of FIG. 5.

FIG. 9 illustrates test point consolidation.

FIG. 10 is a flowchart illustrating a scan design procedure according to embodiment 2.

FIG. 11 is a layout image diagram of a semiconductor integrated circuit according to embodiment 2 of the present invention.

FIG. 12 is a layout image diagram of a semiconductor integrated circuit according to embodiment 2 of the present invention.

FIG. 13 is a flowchart illustrating a scan design procedure according to embodiment 3.

FIG. 14 is a layout image diagram of a semiconductor integrated circuit according to embodiment 3 of the present invention.

FIG. 15 is a layout image diagram of a semiconductor integrated circuit according to embodiment 3 of the present invention.

FIG. 16 is a layout image diagram of a semiconductor integrated circuit according to embodiment 3 of the present invention.

FIG. 17 is a flowchart illustrating a scan design procedure according to embodiment 4.

FIG. 18 is a circuit diagram of a semiconductor integrated circuit in scan design according to embodiment 4.

FIG. 19 is a circuit diagram of a semiconductor integrated circuit in scan design according to embodiment 4.

FIG. 20 is a circuit diagram of a semiconductor integrated circuit in scan design according to embodiment 4.

FIG. 21 is a flowchart illustrating a scan design procedure according to embodiment 5.

FIG. 22 is a circuit diagram of a semiconductor integrated circuit in scan design according to embodiment 5.

FIG. 23 is a circuit diagram of a semiconductor integrated circuit in scan design according to embodiment 5.

FIG. 24 is a flowchart illustrating a scan design procedure according to embodiment 6.

FIG. 25 is a circuit diagram of a semiconductor integrated circuit in scan design according to embodiment 6.

FIG. 26 is a circuit diagram of a semiconductor integrated circuit in scan design according to embodiment 6.

### DESCRIPTION OF THE PREFERRED EMBODIMENTS

Hereinafter, embodiments of the present invention will be described with reference to the drawings.

### Embodiment 1

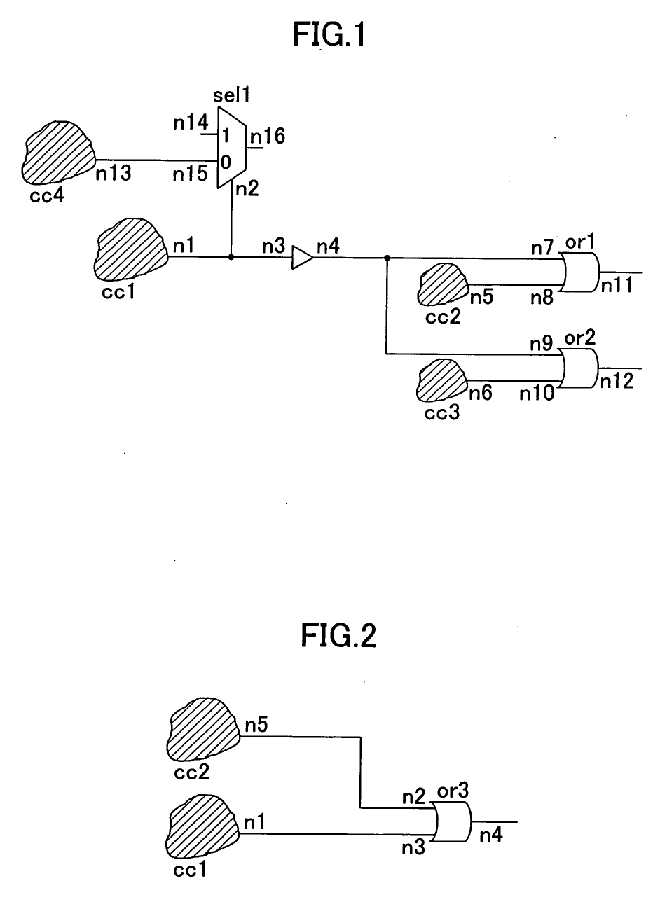

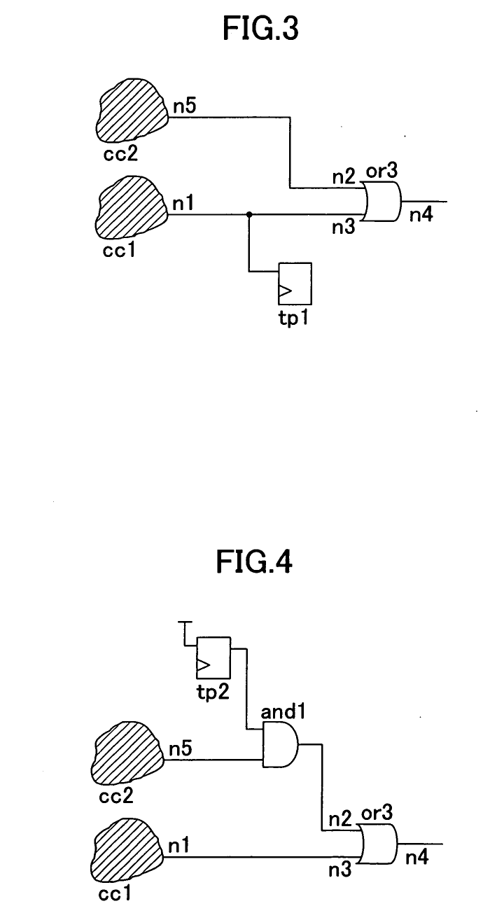

FIG. 1 is a circuit diagram of a semiconductor integrated circuit which is to be subjected to a test point insertion method according to embodiment 1 of the present invention. A group of combinational circuits shown in FIG. 1 includes four combinational circuits cc1 to cc4, 16 nodes n1 to n16, two OR circuits or1 and or2, a selector sel1, and a buffer.

As shown in FIG. 1, the selector sel1 has a control node n2, input nodes n14 and n15, and an output node n16. The control node n2 is connected to an output node n1 of the combinational circuit cc1 and an input node n3 of the buffer. The input node n15 is connected to an output node n13 of the combinational circuit cc4. An OR circuit or1 has input nodes n7 and n8 and an output node n11. The input node n7 is connected to an output node n4 of the buffer. The input node n8 is connected to an output node n5 of the combinational circuit cc2. An OR circuit or2 has input nodes n9 and n10 and an output node n12. The input node n9 is connected to the output node n4 of the buffer. The input node n10 is connected to an output node n6 of the combinational circuit cc3.

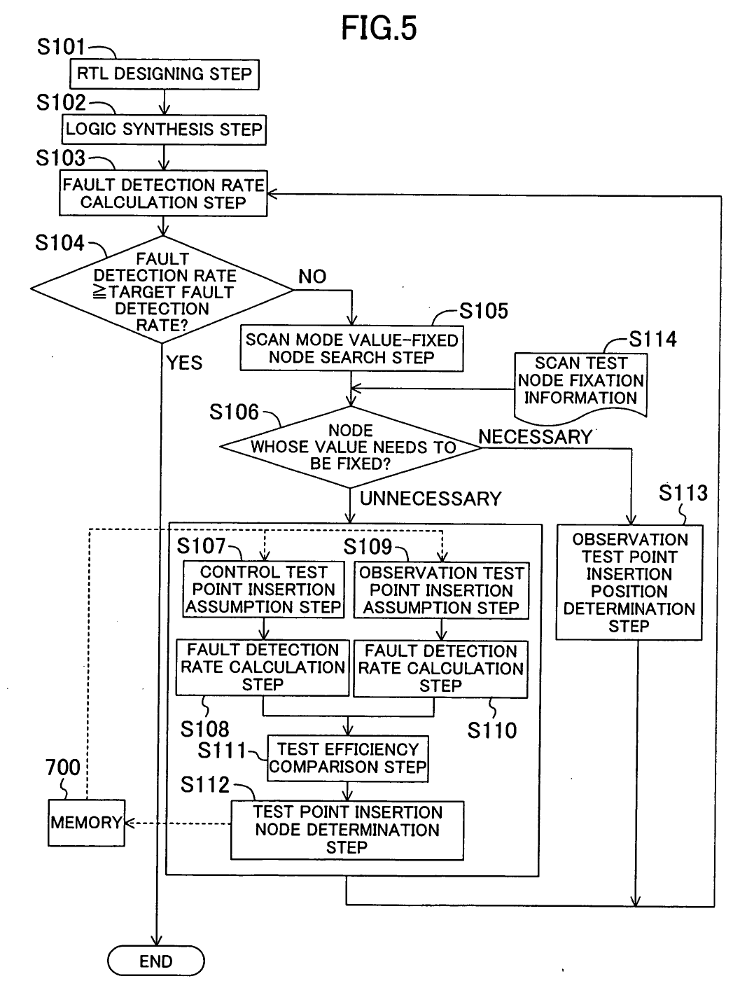

FIG. 5 is a flowchart illustrating a scan design procedure according to embodiment 1. First, at RTL designing step S101, a circuit is designed by RTL description. Then, at logic synthesis step S102, the circuit is optimized using a logic synthesis tool.

Then, at fault detection rate calculation step S103, the fault detection rate of the circuit is calculated. At fault detection rate determination step S104, it is determined whether or not the fault detection rate calculated at step S103 has reached a target fault detection rate. If it is determined at step S104 that the fault detection rate has reached the target fault detection rate, the scan design is terminated. If it is determined at step S104 that the fault detection rate has not reached the target fault detection rate, the procedure proceeds to scan mode value-fixed node search step S105. The processes of step S105 and subsequent steps are performed on a circuit disabled by propagation of a fixed-value of a scan mode signal, which includes the circuit of FIG. 1.

At scan mode value-fixed node search step S105, a node whose value is fixed during the scan mode operation is searched for and extracted. Meanwhile, a list of nodes whose values need to be fixed in scan test is included in scan test node fixation information S114. At step S106 of determining whether or not it is a node whose value needs to be fixed, it is determined according to the scan test node fixation information S114 whether or not a node extracted at value-fixed node search step S105 needs value fixation. The scan test node fixation information S114 is prepared in advance at the step of determining the specifications of scan design.

If it is determined at step S106 that the value of the node needs to be fixed, the procedure proceeds to observation test point insertion position determination step S113. At step S113, it is determined that an observation test point is inserted to be connected to the final output node of a combinational circuit group which is disabled by the node because the values of nodes which need to be fixed cannot be changed during scan test. Then, process returns to fault detection rate calculation step S103, and the fault detection rate is calculated.

If it is determined at step S106 that the value of the node does not need to be fixed, the procedure proceeds to control test point insertion assumption step S107 and observation test point insertion assumption step S109.

At control test point insertion assumption step S107, it is assumed that a control test point is inserted to be connected to a node nearer to the root among nodes whose values do not need to be fixed so that the node becomes 0/1-controllable, i.e., controllable between 0 and 1. Based on this assumption, the controllability and observability are calculated. Then, at fault detection rate calculation step S108, the fault detection rate is calculated based on the calculated controllability and observability.

At observation test point insertion assumption step S109, it is assumed that an observation test point is inserted to be connected to an output node of a combinational circuit disabled by a node whose value does not need to be fixed. Based on this assumption, the observability is calculated. At fault detection rate calculation step S110, the fault detection rate is calculated based on the calculated observability.

Then, the procedure proceeds to test efficiency comparison step S111. At step S111, an improvement (increment) of the fault detection rate calculated at fault detection rate calculation step S108 is divided by the area of a test circuit necessary for the control test point, and an improvement (increment) of the fault detection rate calculated at fault detection rate calculation step S110 is divided by the area of a test circuit necessary for the observation test point. The resultant quotients are compared with each other. In the case where the observation test point is inserted to be connected to the node, this test circuit is a flip flop. In the case where the control test point is inserted to be connected to the node, this test circuit is formed by a flip flop and a logic circuit.

Thereafter, at test point insertion node determination step S112, a test point which achieves the higher test efficiency is selected among the control test point and the observation test point based on the comparison result of the test efficiencies at test efficiency comparison step S111, and a node to which the selected test point is to be connected is determined. At this step, the number of the node determined for insertion of the test point is stored in a memory 700. Then, the process returns to fault detection rate calculation step S103, in which the fault detection rate is calculated.

The circuits which are disabled by propagation of a fixed value of a scan mode signal other than the circuit of FIG. 1 are also subjected to the above process. Specifically, the steps from step S105 to step S113 are repeatedly performed while changing the node to which a test point is inserted till the fault detection rate reaches the target fault detection rate. In this process, the number of the node determined at step S112 for insertion of the test point is stored in the memory 700. At control test point insertion assumption step S107 or observation test point insertion assumption step S109, the process is performed on nodes other than those stored in the memory 700.

The routine from step S105 to step S113 is repeated till the fault detection rate reaches the target fault detection rate, whereby the order of nodes to which the observation test point or control test point determined at test point insertion node determination step S112 is to be inserted is determined, and the order of nodes to which the observation test point determined at observation test point insertion position determination step S113 is determined. When the fault detection rate reaches the target fault detection rate, the observation test points and/or control test points are inserted to be connected to the nodes sequentially in the determined order.

The steps of the flowchart shown in FIG. 5 are described specifically with reference to the circuit diagram of the semiconductor integrated circuit shown in FIG. 1.

The above-described group of combinational circuits is configured such that the output node n1 of the combinational circuit cc1 is fixed to 1, whereby the node n2 is fixed to 1 in scan test. Thus, in the scan design, information that the node n2 is fixed among all the nodes is given as scan test node fixation information S114.

Herein, consider a case where the number of nodes included in the combinational circuits cc1, cc2, cc3, and cc4 (N_1, N_2, N_3, and N_4) are N_1=5, N_2=5, N_3=5, and N_4=5, respectively. It is further assumed that the number of faults included in the combinational circuits cc1, cc2, cc3, and cc4 (F_1, F_2, F_3, and F_4) are F_1=10, F_2=10, F_3=10, and F_4=10, respectively. Herein, the “fault(s)” means a stuck-at-1 fault and a stuck-at-0 fault for each node.

Herein, “F_all” is the number of all faults in the combinational circuit group. The faults includes faults in the circuit cc1, faults in the circuit cc2, faults in the circuit cc3, faults in the circuit cc4, a fault at the node n3, a fault at the node n3, a fault at the node n4, a fault at the node n7, a fault at the node n8, a fault at the node n9, a fault at the node n10, a fault at the node n11, a fault at the node n12, a fault at the node n14, a fault at the node n15, and a fault at the node n16. Thus, F_all=10+10+10+10+20=60.

Where the number of faults which are detectable when the node n1 is fixed to 1 is F_d, such detectable faults include {a stuck-at-0 fault at the node n1, a stuck-at-0 fault at the node n2, a stuck-at-0 fault at the node n3, a stuck-at-0 fault at the node n4, a stuck-at-0 fault at the node n7, a stuck-at-0 fault at the node n9, a stuck-at-0 fault at the node n11, a stuck-at-0 fault at the node n12, a stuck-at-0/1 fault at the node n14, and a stuck-at-0/1 fault at the node n16}, and therefore, F_d=12. It should be noted that the “detectable faults” herein mean the faults which are observable at an external output or a scan flip flop. In this embodiment, the target fault detection rate is set to 95%.

Referring to FIG. 5, at fault detection rate calculation step S103, the fault detection rate is calculated by the formula of (F_d/F_all)×100 [%]. With the above values assigned into this formula, the fault detection rate results in ( 12/60)×100=20%. Since the target fault detection rate is 95%, it is determined at fault detection rate determination step S104 that the fault detection rate calculated at step S103 is lower than the target fault detection rate. Thus, the procedure proceeds to scan mode value-fixed node search step S105.

In the combinational circuit group, the values of the nodes n1 and n2 are fixed. Accordingly, the values of the nodes n3, n4, n7, n9, n11, and n12 are also fixed. Therefore, at scan mode value-fixed node search step S105, the value-fixed nodes n1, n2, n3, n4, n7, n9, n11, and n12 are extracted. At determination step S106, the 8 extracted nodes are collated with scan test node fixation information S114 to be determined as to whether or not the values of these nodes need to be fixed.

As previously described, scan test node fixation information S114 includes information that, among all the nodes, the value of the node n2 is to be fixed. Therefore, it is determined at determination step S106 that, among the 8 nodes, the value needs to be fixed only at the node n2, while the value does not need to be fixed at the remaining 7 nodes other than the node n2.

As to the node n2 which has been determined to need value fixation, it is determined at observation test point insertion position determination step S113 that an observation test point is to be inserted to be connected to the output node n13 of the combinational circuit cc4 which is unobservable due to the fixed value of the node n2. In the case where an observation test point is inserted to be connected to the output node n13, the fault detection rate is calculated by the formula of {(F_d+F_4)/F_all}×100[%] at fault detection rate calculation step S103. With the above values assigned into this formula, the fault detection rate results in {(12+10)/60}1×100≈37%.

As to the 7 nodes n1, n3, n4, n7, n9, n11, and n12 which have been determined to need no value fixation, at control test point insertion assumption step S107, it is assumed that a control test point is inserted to be connected to the node n3, which is nearer to the root among these value-fixed nodes, such that the node n3 is 0/1-controllable, i.e., controllable between 0 and 1. In this state, the following faults are detectable: {F_2, F_3, a stuck-at-1 fault at the node n3, a stuck-at-1 fault at the node n4, a stuck-at-1 fault at the node n7, a stuck-at-1 fault at the node n9, a stuck-at-1 fault at the node n11, and a stuck-at-1 fault at the node n12}.

Then, the controllability and observability are calculated based on the above assumption, and the fault detection rate is calculated at fault detection rate calculation step S108. At step S108, the fault detection rate is calculated by the formula of {(F_d+F_4+F_2+F_3+6)/F_all}×100[%]. With the above values assigned into this formula, the fault detection rate results in {(12+10+10+10+6)/60}×100=80%.

Then, at observation test point insertion assumption step S109, it is assumed that observation test points are inserted to be connected to the output node n5 of the combinational circuit cc2 and the output node n6 of the combinational circuit cc3 which are unobservable due to the value-fixed nodes n7 and n9. In this state, the following faults are detectable: {F_2, F_3, a stuck-at-0/1 fault at the node n8, and a stuck-at-0/1 fault at the node n10}.

Then, the observability is calculated based on the above assumption. At fault detection rate calculation step S110, the fault detection rate is calculated based on the calculated observability. At step S110, the fault detection rate is calculated by the formula of {(F_d+F_4+F_2+F_3+4)/F_all}×100[%]. With the above values assigned into this formula, the fault detection rate results in {(12+10+10+10+4)/60}×100≈77%.

Then, at test efficiency comparison step S111, an improvement (increment) of the fault detection rate calculated at fault detection rate calculation step S108 per unit area of a test circuit (hereinafter, referred to as “control test point (CTP) insertion test efficiency”) and an improvement (increment) of the fault detection rate calculated at fault detection rate calculation step S110 per unit area of a test circuit (hereinafter, referred to as “observation test point (OTP) insertion test efficiency”) are calculated and compared with each other.

Herein, the test circuit which is necessary for insertion of a control test point to one node is formed by one 2-input selector and one flip flop. In a commonly-employed circuit, the area of the 2-input selector is smaller than that of the flip flop. In this embodiment, it is assumed that the area of the 2-input selector is Area_S=1, and the area of the flip flop is Area_F=2. In this case, the control test point insertion test efficiency is calculated by the following formula:
[{(F_{—}d+F_{—}4+F_{—}2+F_{—}3+6)/F_all}×100−{(F_{—}d+F_{—}4)/F_all}×100]/(Area_{—}S+Area_{—}F)=(F_{—}2+F_{—}3+6)×100/{F_all×(Area_{—}S+Area_{—}F)}[%].
With the above values assigned into this formula, the control test point insertion test efficiency results in (10+10+6)×100/{60×(1+2)}=14.44%.

On the other hand, the test circuit which is necessary for insertion of an observation test point at one node is formed by one flip flop. Since in this embodiment observation test points are inserted to be connected to two nodes, i.e., the nodes n5 and n6, the observation test point insertion test efficiency is calculated by the following formula:
[{(F_{—}d+F_{—}4+F_{—}2+F_{—}3+4)/F_all}×100−{(F_{—}d+F_{—}4)/F_all}×100]/(Area_{—}F+Area_{—}F)=(F_{—}2+F_{—}3+4)×100/(F_all×2Area_{—}F)[%].
With the above values assigned into this formula, the observation test point insertion test efficiency results in (10+10+4)×100/(60×2×2)=10%.

Comparing the control test point insertion test efficiency and the observation test point insertion test efficiency, the ratio of these efficiencies, RE, is as follows:

$$\begin{matrix}RE = ( CTP insertion test efficiency ) / ( OTP insertion test efficiency ) \\ = [ ( F\_ 2 + F\_ 3 + 6 ) / \{ F\_all \times ( Area\_S + Area\_F ) \} ] / \{ ( F\_ 2 + F\_ 3 + 4 ) / ( F\_all \times 2 Area\_F ) \} .\end{matrix}$$

Herein, assuming that F_2+F_3=F_23,

$$\begin{matrix}RE = [ ( F\_ 23 + 6 ) / \{ F\_all \times ( Area\_S + Area\_F ) \} ] / \{ ( F\_ 23 + 4 ) / ( F\_all \times 2 Area\_F ) \} \\ = \{ ( F\_ 23 + 6 ) \times ( F\_all \times 2 Area\_F ) \} / [ ( F\_ 23 + 4 ) \times \{ F\_all \times ( Area\_S + Area\_F ) \} ] .\end{matrix}$$

Since in a generally-used circuit the area of a 2-input selector is smaller than that of a flip flop,

$$RE > \{ ( F\_ 23 + 6 ) \times ( F\_all \times 2 Area\_F ) \} / \{ ( F\_ 23 + 4 ) \times ( F\_all \times 2 Area\_F ) \} = ( F\_ 23 + 6 ) / ( F\_ 23 + 4 ) > 1.$$

In summary of the above,
(CTP insertion test efficiency)/(OTP insertion test efficiency)={(F_{—}23+6)×(F_all×2Area_{—}F)}/[(F_{—}23+4)×{F_all×(Area_{—}S+Area_{—}F)}]>1.

Specifically, in this embodiment, (CTP insertion test efficiency)/(OTP insertion test efficiency) is 14.44/10=1.44. As seen from this result, the control test point insertion test efficiency is higher than the observation test point insertion test efficiency. Therefore, at test point insertion node determination step S112, it is determined that a control test point is to be inserted to be connected to the node n3.

This embodiment includes step S106 of determining whether or not it is a node whose value needs to be fixed for scan design. It is determined that an observation test point is inserted to a node which needs value fixation. On the other hand, it is assumed at control test point insertion assumption step S107 that a control test point is inserted to be connected to a node which does not need value fixation, and it is assumed at observation test point insertion assumption step S109 that an observation test point is inserted to be connected to a node which does not need value fixation. Based on such assumptions, the type of a test point and a node to which the test point is to be inserted are determined while comparing the improvements (increments) of the fault detection rates per unit area of the test circuits.

In the conventional scan test method, it is not considered whether the higher test efficiency is achieved by insertion of an observation test point to a line or by insertion of a control test point to a line in order to improve the confirmability as to the presence/absence of fault detection at any single point. Thus, when an observation test point is inserted to a line, the area of a test circuit increases and, in addition, the fault detection rate per unit area of the test circuit decreases.

In contrast, according to this embodiment, it is determined that an observation test point or control test point is inserted at a node of higher test efficiency among a node at which an observation test point is to be inserted and a node at which a control test point is to be inserted. With this feature, the number of test points inserted to nodes is decreased, whereby the area of the test circuit is reduced, and the fault detection rate per unit area of the test circuit increases.

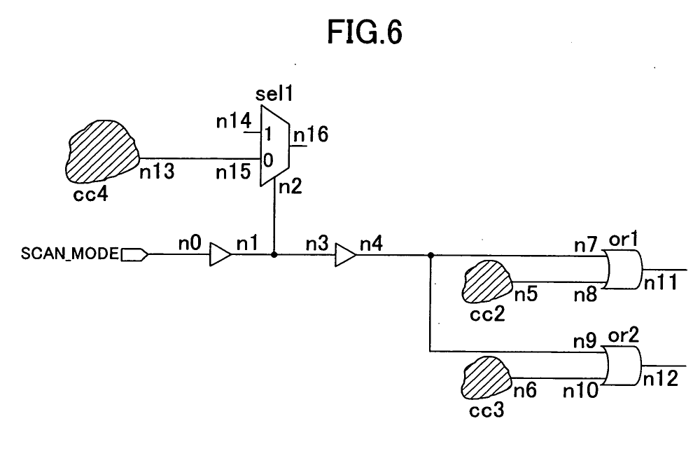

A method for generating scan test node fixation information S114 is now described. FIG. 6 is a circuit diagram of a variation of the circuit of FIG. 1. The circuit of FIG. 6 includes a buffer circuit, which has external input terminal SCAN_MODE, in substitution for the combinational circuit cc1 of FIG. 1. Terminal SCAN_MODE is fixed at 1 in scan test.

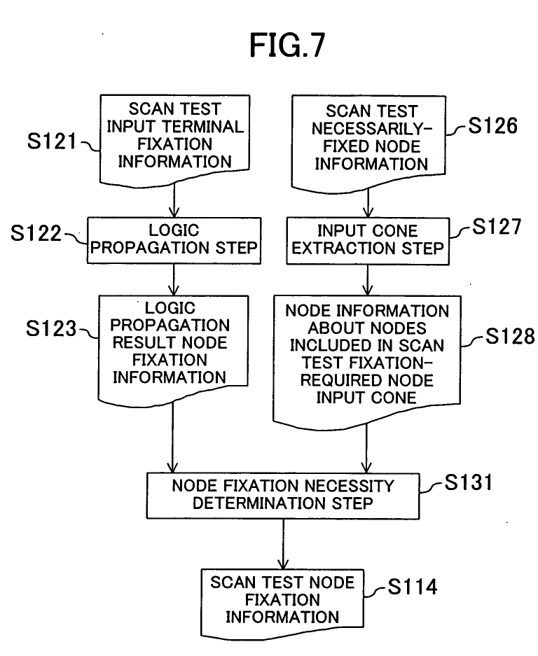

FIG. 7 is a flowchart illustrating a process of generating scan test node fixation information S114. First, “SCAN_MODE=1” is given as scan test input terminal fixation information S121 which is information about an input terminal whose value is fixed in scan test, and “n2=1” is given as scan test necessarily-fixed node information S126 which is information about a node which is necessarily fixed in scan test.

At logic propagation step S122, a result of logic propagation of a fixed value in scan test is obtained based on input terminal fixation information S121. The obtained result, logic propagation result node fixation information S123, is {n0=1, n1=1, n2=1, n3=1, n4=1, n7=1, n9=1, n11=1, n12=1}.

Meanwhile, at input cone extraction step S127, nodes included in an input cone of the necessarily-fixed node are extracted based on scan test necessarily-fixed node information S126. The extracted nodes, node information S128 about nodes included in scan test fixation-required node input cone, are {n0, n1, n2}.

At node fixation necessity determination step S131, information about nodes in node information S128, {n0, n1, n2}, are selected from logic propagation result node fixation information S123 {n0=1, n1=1, n2=1, n3=1, n4=1, n7=1, n9=1, n11=1, n12=1}, and the extracted information regarding the nodes n0 to n2, {n0=1, n1=1, n2=1}, are stored as scan test node fixation information S114.

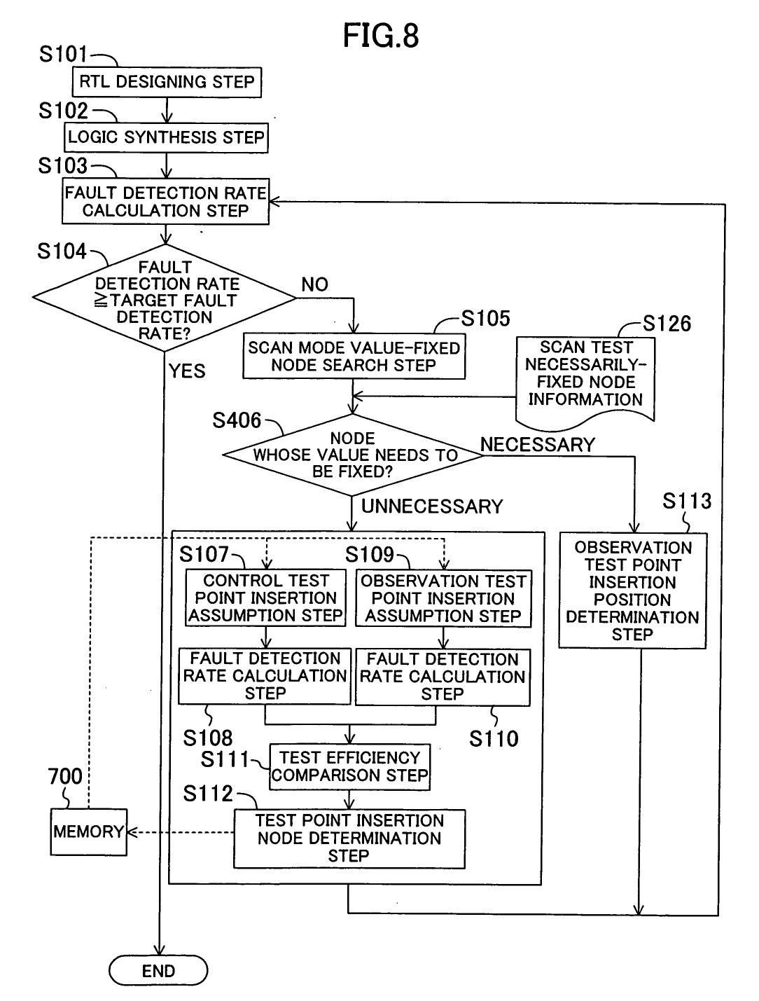

FIG. 8 is a flowchart illustrating a variation of the process of FIG. 5. In the flowchart of FIG. 8, at step S146 of determining whether or not it is a node whose value needs to be fixed, it is determined whether or not value fixation is necessary at a value-fixed node after the process of input cone extraction step S127 of FIG. 7.

At determination step S146, if a value-fixed node is included in an input cone of a node whose value needs to be fixed in scan test, it is determined that the value of the value-fixed node needs to be fixed. If otherwise, it is determined that the value of the value-fixed node does not need to be fixed.

### Embodiment 2

In this section, a test point insertion method is described wherein consolidatable test points are consolidated into a single point.

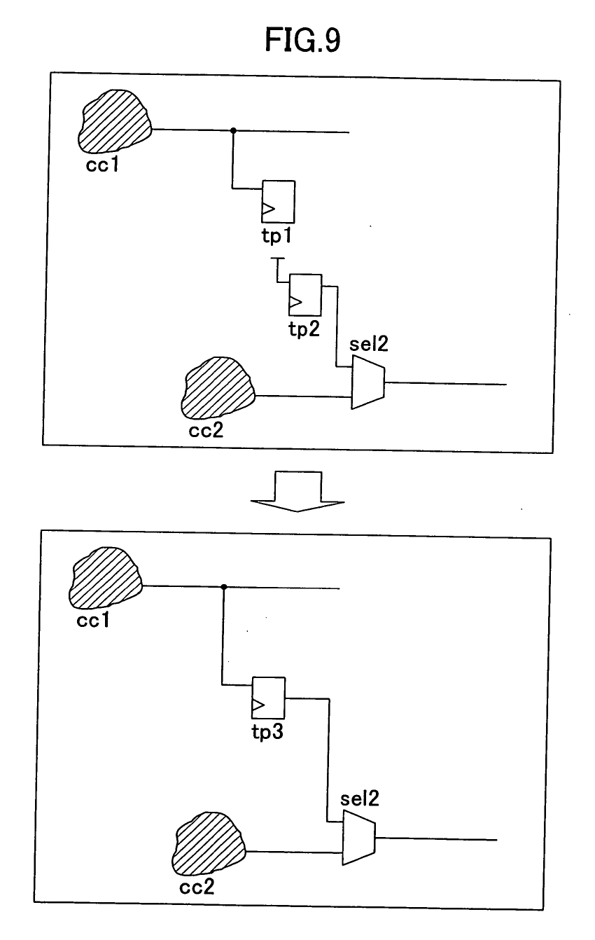

FIG. 9 illustrates a widely-known test point consolidation technique. In this technique, if an observation test point tp1 inserted to the output node of the combinational circuit cc1 and a control test point tp2 inserted to the output node of the combinational circuit cc2 via a selector sel2 are consolidatable, the test points tp1 and tp2 are replaced by a test point tp3.

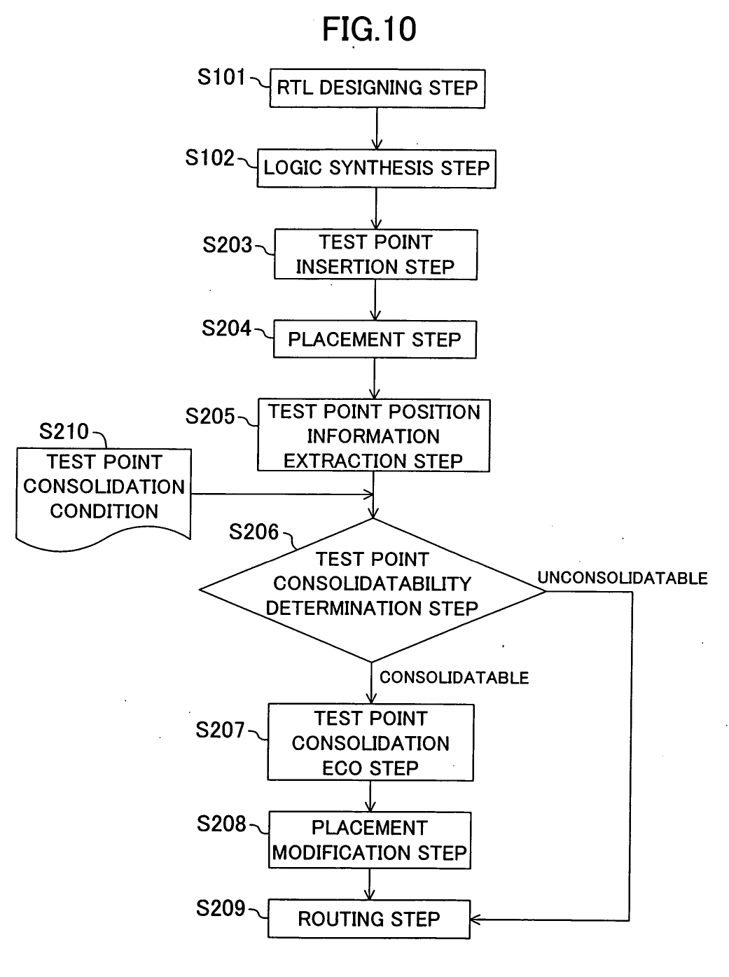

FIG. 10 is a flowchart illustrating a scan design procedure according to embodiment 2. The scan design procedure of embodiment 2 is basically the same as that of embodiment 1, and therefore, only the differences from the procedure of embodiment 1 are described. In the flowchart of FIG. 10, determination as to whether test points are consolidatable or nor is made after cells has been placed.

First, at test point insertion step S203, test points are inserted to respective nodes based on a netlist generated at RTL designing step S101 and logic synthesis step S102. The test points include observation test points and control test points. These test points are determined in the same way as that described in embodiment 1. After cell placement at placement step S204, the procedure proceeds to test point position information extraction step S205.

At test point position information extraction step S205, in a circuit over which the test points and cells are placed, the coordinates of each test point and the congestion degree of a wired area around the test point are extracted. The wired area congestion degree means the wired area use state within a unit box of the wired area which is used for general routing in the cell placement process.

At test point consolidatability determination step S206, it is determined based on test point consolidation condition S210 whether or not the placed test points are consolidatable. Test point consolidation condition S210 is physical specifications, such as the linear distance between nodes to which a test point is inserted, the routing congestion degree in an area between test points, etc. These specifications are determined according to the characteristics of a circuit and the production process used, with understanding of the specific features thereof, without affecting the function designing during the cell placement and general routing processes.

If it is determined at test point consolidatability determination step S206 that test points are consolidatable, the procedure proceeds to test point consolidation ECO step S207. If it is determined at step S206 that test points are not consolidatable, the procedure proceeds to routing step S209.

At test point consolidation ECO step S207, the circuit is modified according to ECO (Engineering Change Order) such that consolidatable test points are consolidated into a single test point. Then, at placement modification step S208, the placement of the consolidated test point and cells therearound is modified. The process of placement modification step S208 is repeatedly performed on every consolidated test point. At routing step S209, the consolidated test points are connected to corresponding nodes, and then, the procedure proceeds to a semiconductor integrated circuit designing step.

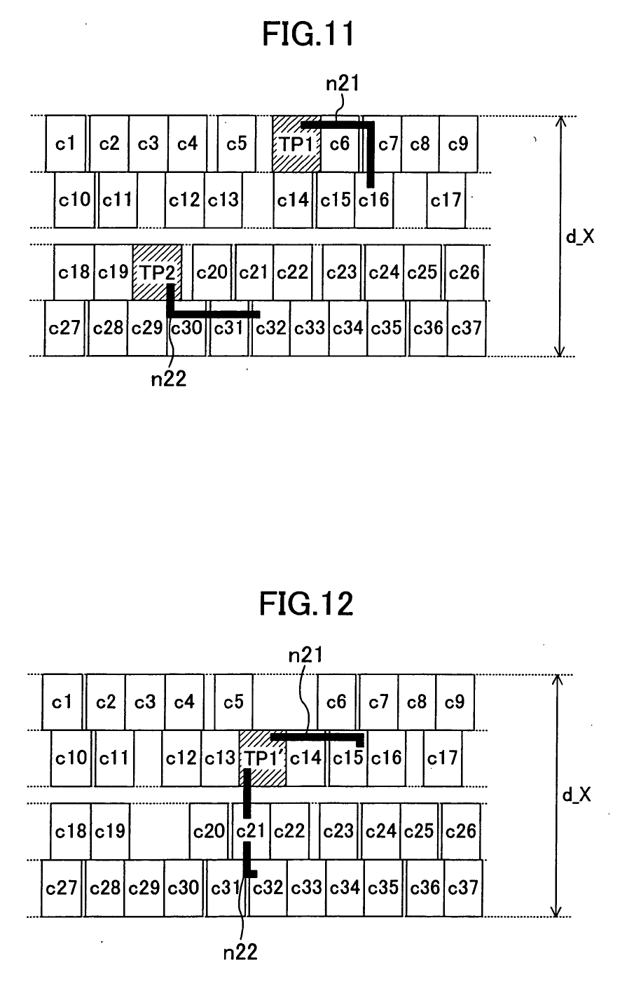

The steps of the flowchart of FIG. 10 are specifically described with reference to the layout image diagrams of a semiconductor integrated circuit shown in FIG. 11 and FIG. 12.

The layout image diagram of FIG. 11 shows an exemplary arrangement obtained after test points TP1 and TP2 are inserted at test point insertion step S203 and cells are placed at subsequent placement step S204. A first node n21 to which the test point TP1 is inserted and a second node n22 to which the test point TP2 is inserted are positioned such that the linear distance between the first node n21 and the second node n22 is d_X or shorter. Herein, the condition that “the linear distance between nodes to which test points are inserted is d_X or shorter” is given as test point consolidation condition S210. At test point consolidatability determination step S206, the test points TP1 and TP2 are determined to be consolidatable because the test points TP1 and TP2 satisfy test point consolidation condition S210.

At test point consolidation ECO step S207, the test point TP2 is deleted and the test point TP1 is changed to a test point TP1′, whereby the test point TP1 and the test point TP2 are consolidated into the test point TP1′. Alternatively, although not shown, at test point consolidation ECO step S207, it is also possible that the test point TP1 is deleted and the test point TP2 is changed to a test point TP2′, whereby the test point TP1 and the test point TP2 are consolidated into the test point TP2′.

Then, at placement modification step S208, some modifications are made to the placement of the test point TP1′ and cells around the test point TP1′. In this embodiment, the interval between cell c13 and cell c14 is extended at placement modification step S208 (see FIG. 12). At this step, a conventionally-known, generally-employed method may be used for modifying the placement. The modification is made without substantially affecting the circuit in normal operation. Thereafter, at routing step S209, both the first node n21 and the second node n22 are connected to the test point TP1′.

It should be noted that test point consolidation condition S210 is not limited to the condition that “the linear distance between nodes to which test points are inserted is d_X or shorter” but may be the condition that “the Manhattan distance between nodes to which test points are inserted is d_X or shorter”. Herein, the Manhattan distance is the sum of the absolute values of differences in the values of coordinates between nodes. Alternatively, the condition that “the congestion degree between nodes to which test points are inserted is d_n or lower” may be given as test point consolidation condition S210. The congestion degree can be, in general, expressed by the maximum number of lines in a unit area which are used for estimation of lines in the cell placement step.

Conventionally, determination as to whether or not test points are consolidatable is made before the cell placement step. Therefore, the linear distance between a consolidated test point prepared in advance on the netlist and a corresponding node becomes large at the cell placement step. Accordingly, the line connecting the test point and the node becomes long, and the wired area increases.

In contrast, this embodiment includes test point consolidatability determination step S206 after placement step S204 in order to consolidate consolidatable test points while confirming the placement of cells. With this feature, the congestion degree of the wired area is relaxed. Further, the length of a line is decreased as compared with a conventional layout, whereby the wired area is reduced. Accordingly, the interconnect capacitance is suppressed to alleviate timing damage to a circuit in normal operation.

### Embodiment 3

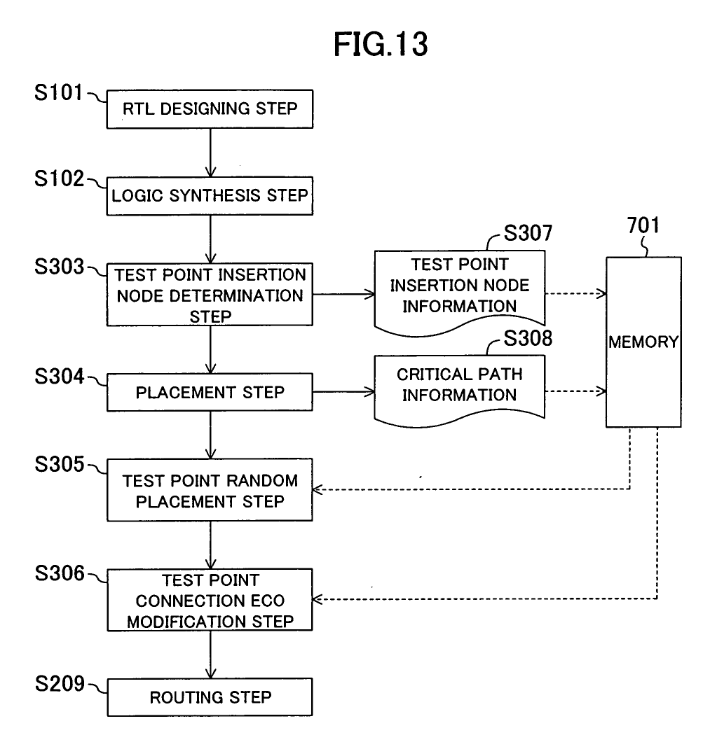

FIG. 13 is a flowchart illustrating a scan design procedure according to embodiment 3. The scan design procedure of embodiment 3 is basically the same as that of embodiment 1, and therefore, only the differences from embodiment 1 are described.

First, at test point insertion node determination step S303, nodes to which test points are to be inserted are determined based on a netlist generated at RTL designing step S101 and logic synthesis step S102. These test points are determined in the same way as that described in embodiment 1. The information about the node determined at step S303 for test point insertion is output as test point insertion node information S307. It should be noted that, at test point insertion node determination step S303, only the task of determining a node to which a test point is to be inserted is carried out, but the task of actually inserting the node to the test point is not performed.

Then, cells are placed at placement step S304 wherein critical path information S308 is output. Test point insertion node information S307 and critical path information S308 are stored in the form of a database, or the like, in a memory 701.

Then, at test point random placement step S305, flip flops are randomly placed to a number equal to the number of nodes determined for test point insertion which is stored in the memory 701. For example, when a control test point is placed, a logic circuit necessary for a structure which is made controllable by the control test point, i.e., an AND circuit which is necessary for 0-control (i.e., setting the value to 0), an OR circuit which is necessary for 1-control (i.e., setting the value to 1), a selector, or the like, is also positioned in the vicinity of the flip flop. Herein, random placement means placing flip flops in a dispersed fashion in an area where the congestion degree of cells and lines is lower than a predetermined reference value while confirming the placement of already-positioned cells.

Then, at test point connection ECO modification step S306, the connection information about the connections between the randomly placed test points and the nodes to which the test points are to be inserted is generated based on test point insertion node information S307 and critical path information S308 stored in the memory 701. The test point connection information is generated for all the nodes, and the connection is actually modified based on ECO.

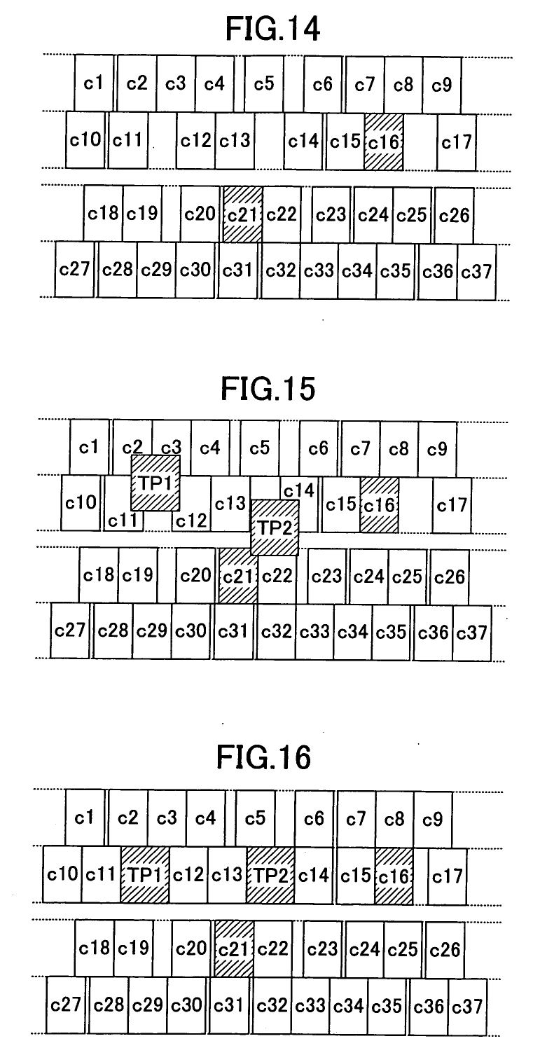

The steps of the flowchart of FIG. 13 are specifically described with reference to the layout image diagrams of a semiconductor integrated circuit shown in FIG. 14, FIG. 15 and FIG. 16.

The layout image diagram of FIG. 14 shows an exemplary arrangement obtained after it is determined at step S303 that test points are to be inserted to the nodes n16 and n21 extending from terminals of cells c16 and c21 and the cells are placed at placement step S204. Test point insertion node information S307 includes the nodes n16 and n21. Critical path information S308 includes the node n21.

First, as shown in FIG. 1, at test point random placement step S305, flip flops are randomly placed to a number equal to the number of nodes determined for test point insertion. Then, as shown in FIG. 16, the placement is modified to extend the interval between a cell c11 and a cell c12 and the interval between a cell c13 and a cell c14 such that test points TP1 and TP2 are placed within the cell placement area. The placement modifying function of a commercially-available layout tool can be used in this process.

Thereafter, at test point connection ECO modification step S306, the connection information about connection between the test points TP1 and TP2 and the nodes n16 and n21 is generated based on test point insertion node information S307 and critical path information S308 stored in the memory 701. Then, the connection between the test point TP1 and the node n16 and the connection between the test point TP2 and the node n21 are modified based on ECO.

This embodiment includes test point random placement step S305 after placement step S304, wherein test points are placed after the cell placement step. Therefore, the test points are inserted to the nodes without substantially affecting the circuit in normal operation. Thereafter, timing violation which can be caused due to test point insertion is reduced.

As described above, at test point connection ECO modification step S306, the connections between the test points and the nodes are modified based on test point insertion node information S307 and critical path information S308. Thus, insertion of a test circuit to a critical path in placement and synthesis is avoided, and accordingly, timing designing is effectively carried out.

### Embodiment 4

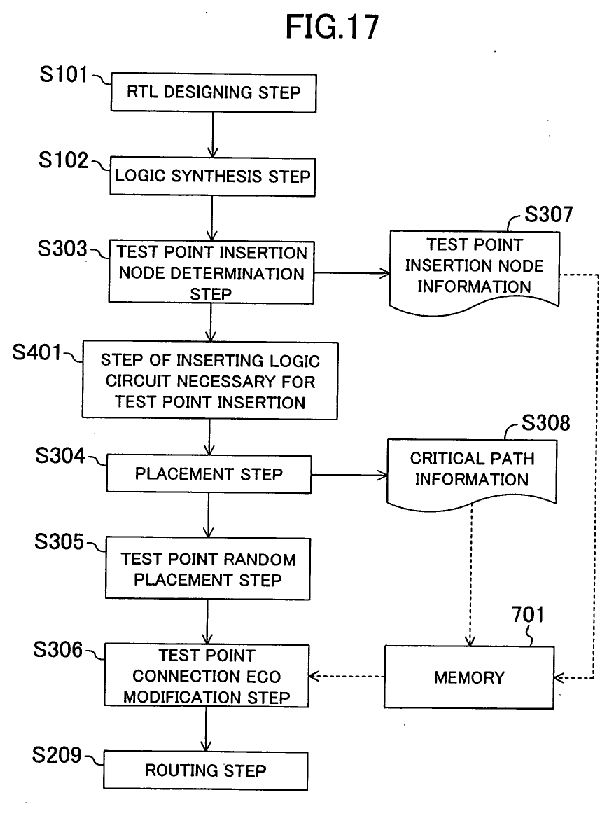

FIG. 17 is a flowchart illustrating a scan design procedure according to embodiment 4. The scan design procedure of embodiment 4 is basically the same as that of embodiment 3, and therefore, only the differences from embodiment 3 are described.

In this embodiment, step S401 of inserting a logic circuit which is necessary for test point insertion is provided between test point insertion node determination step S303 and placement step S304.

Specifically, step S401 of inserting a logic circuit which is necessary for test point insertion is the step of inserting an AND circuit, OR circuit, or a selector, which is necessary for the structure of a control test point. This control test point has the structure where an AND circuit is inserted for enabling 0-control, the structure where an OR circuit is inserted for enabling 1-control, or the structure where a selector is inserted for selecting a route of a control register when a scan enable signal is 1 for the purpose of enabling 0/1-control.

In the combinational circuit group shown in FIG. 4, specifically, the output node n5 of the combinational circuit cc2 is fixed to 1 in scan test. Thus, an AND circuit and1 is inserted to be connected to the output node n5 at insertion step S401. One of the input nodes of the AND circuit and1 is connected to the output node n5 while the output node of the AND circuit and1 is connected to the input node n2 of an OR circuit or3.

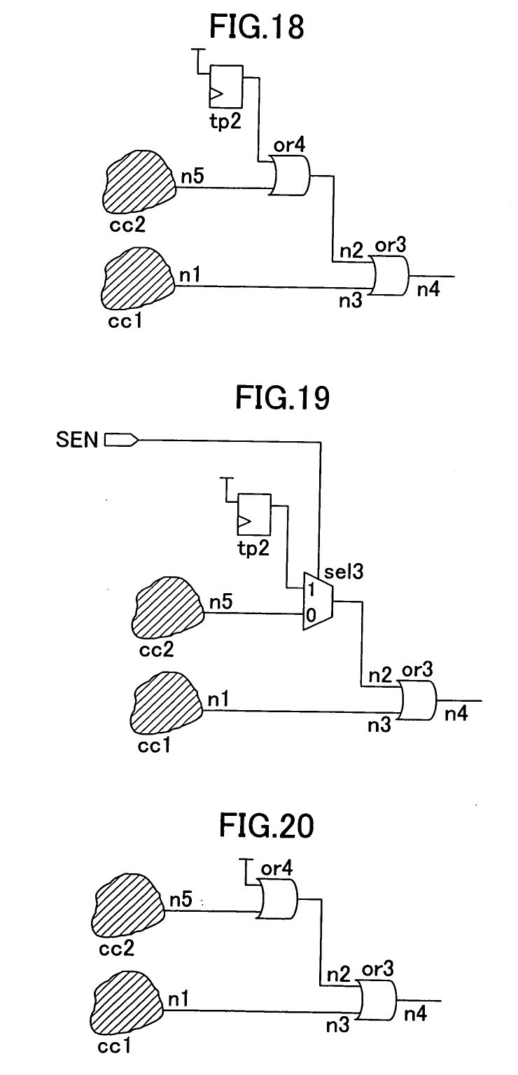

In the combinational circuit group shown in FIG. 18, the output node n5 of the combinational circuit cc2 is fixed to 0 in scan test. Thus, an OR circuit or4 is inserted to be connected to the output node n5 at insertion step S401. One of the input nodes of the OR circuit or4 is connected to the output node n5 while the output node of the OR circuit or4 is connected to the input node n2 of the OR circuit or3.

In the combinational circuit group shown in FIG. 19, the output node n5 of the combinational circuit cc2 is fixed in scan test. Thus, a selector sel3 is inserted to be connected to the output node n5 at insertion step S401. One of the input nodes of the selector sel3 is connected to the output node n5 while the output node of the selector sel3 is connected to the input node n2 of the OR circuit or3.

For example, in the case of a structure for enabling 1-control as shown in FIG. 18, an input terminal of the OR circuit or4 which is connected to a control test point is connected to the power supply (see FIG. 20) in order to avoid affecting the circuit logic during normal operation. If an AND circuit (AND circuit and1) is used for 0-control in place of the OR circuit or4, one of the input terminals of the AND circuit and1 is connected to the ground. If a selector (selector sel3) is used in place of the OR circuit or4, the circuit is designed such that a signal at a terminal of the selector sel3 is always OFF during normal operation. It should be noted that the circuit of FIG. 18 is different from the circuit of FIG. 20 in that a control test point tp2 is connected to one of the input nodes of the OR circuit or4 at test point connection ECO modification step S306.

In this embodiment, step S401 of inserting a logic circuit which is necessary for test point insertion is provided before placement step S304. Since a logic circuit which is necessary for test point insertion is inserted before placement of cells, the timing designing is more effectively carried out.

### Embodiment 5

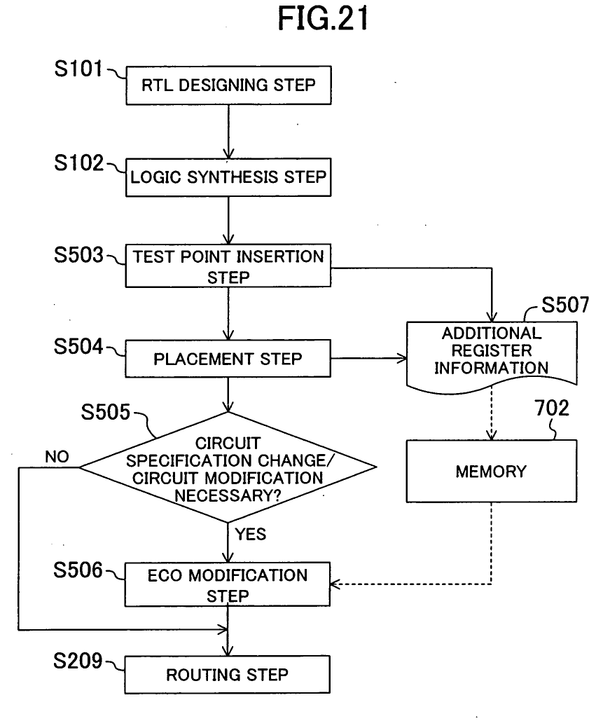

FIG. 21 is a flowchart illustrating a scan design procedure according to embodiment 5. The scan design procedure of embodiment 5 is basically the same as that of embodiment 1, and therefore, only the differences from embodiment 1 are described.

First, at test point insertion step S503, test points are inserted to respective nodes based on a netlist generated at RTL designing step S101 and logic synthesis step S102. These test points are determined in the same way as that described in embodiment 1. The information about the test points inserted at step S503 is output as additional register information S507. Then, at placement step S504, cells are placed. The information about the coordinates of the test points which are obtained at placement step S504 is added to additional register information S507. Additional register information S507 is stored in the form of a database, or the like, in a memory 702.

Then, at circuit specification change/circuit modification necessity determination step S505, it is determined whether or not change of the circuit specifications or circuit modification is necessary. If change to the circuit specifications or modification to the circuit is necessary, the procedure proceeds to ECO modification step S506. At ECO modification step S506, the circuit is modified using a test point included in additional register information S507 as a tool for circuit repair with a register, i.e., part of a repair cell. If none of change to the circuit specifications and modification to the circuit is necessary, the procedure proceeds to routing step S209.

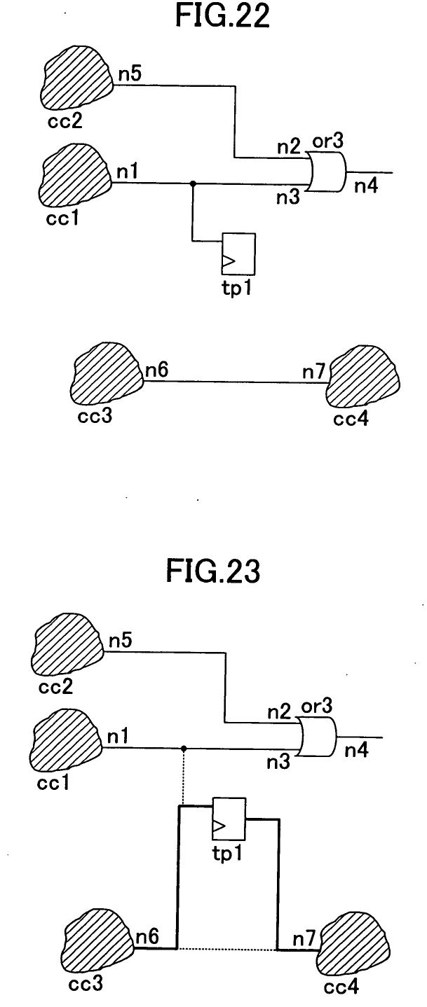

The steps of the flowchart of FIG. 21 are specifically described with reference to the layout image diagrams of a semiconductor integrated circuit shown in FIG. 22 and FIG. 23.

In FIG. 22, an OR circuit or3 of the combinational circuit group includes an output node n4 and input nodes n2 and n3. The input node n3 is connected to an output node n1 of a combinational circuit cc1. The input node n2 is connected to an output node n5 of a combinational circuit cc2. An output node n6 of a combinational circuit cc3 is connected to an input node n7 of a combinational circuit cc4.

In scan test, the output node n5 of the combinational circuit cc2 is fixed to 1. Therefore, an observation test point tp1 is inserted to be connected to the output node n1 of the unobservable combinational circuit cc1 at test point insertion step S503. At test point insertion step S503, the node name “n1”, the instance name “tp1”, and the cell name “FF1” (it is assumed herein that a cell FF1 is used) of the node observed through the observation test point tp1 are output as additional register information S507. Then, cells are placed at placement step S504, and the coordinate information of the observation test point tp1 is added to additional register information S507.

Now, consider a case where it is necessary to modify the circuit such that a register is added between the combinational circuit cc3 and the combinational circuit cc4. At circuit specification change/circuit modification necessity determination step S505, it is determined that modification to the circuit is necessary, and the procedure proceeds to ECO modification step S506. At ECO modification step S506, the data input connection from the output node n1 to the observation test point tp1 is disconnected based on additional register information S507, whereby the output node n6 and the input node n7 are disconnected as shown in FIG. 23. Then, the output node n6 is connected to the data input of the observation test point tp1, and the input node n7 is connected to the data output of the observation test point tp1.

In this embodiment, at ECO modification step S506, the circuit is modified based on additional register information S507. Thus, in the case where the necessity of repairing the circuit occurs after the cell placement step, a test point provided for improving the fault detection rate is used as a repair cell for circuit modification. Therefore, according to this embodiment, it is not necessary to provide a register in a cell called a repair cell, which does not have connection information. Accordingly, the area of the test circuit is further reduced.

### Embodiment 6

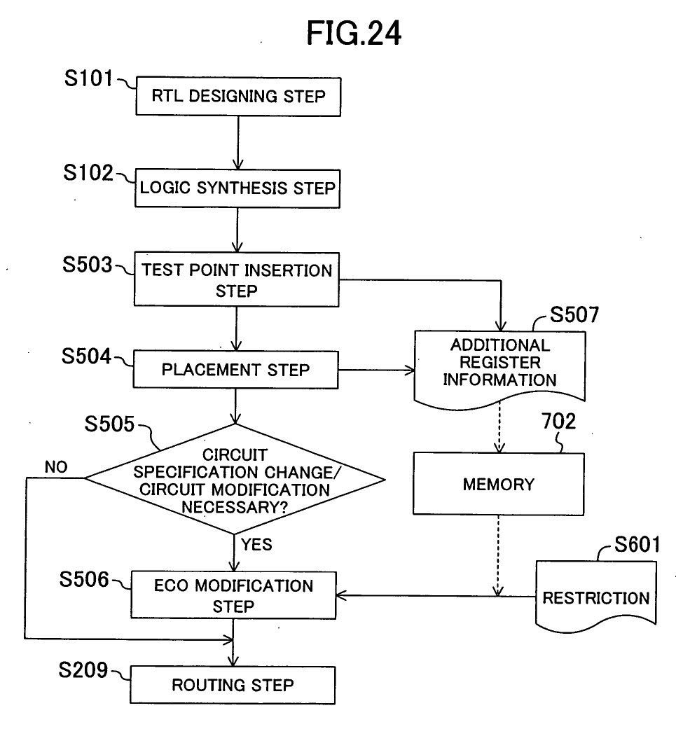

FIG. 24 is a flowchart illustrating a scan design procedure according to embodiment 6. The scan design procedure of embodiment 6 is basically the same as that of embodiment 5, and therefore, only the differences from embodiment 5 are described.

This embodiment includes restriction S601 which requires that only a control test point be usable for a register at ECO modification step. At ECO modification step S506, the circuit is modified based on restriction S601.

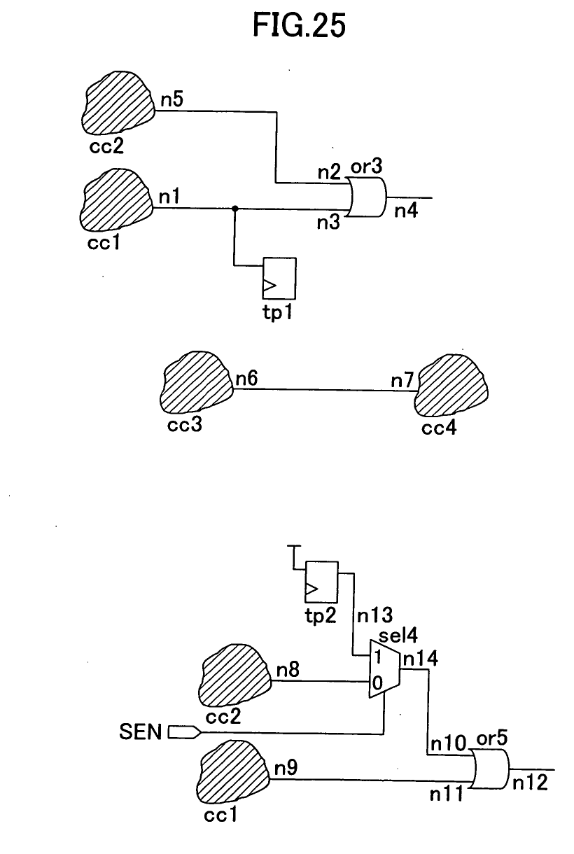

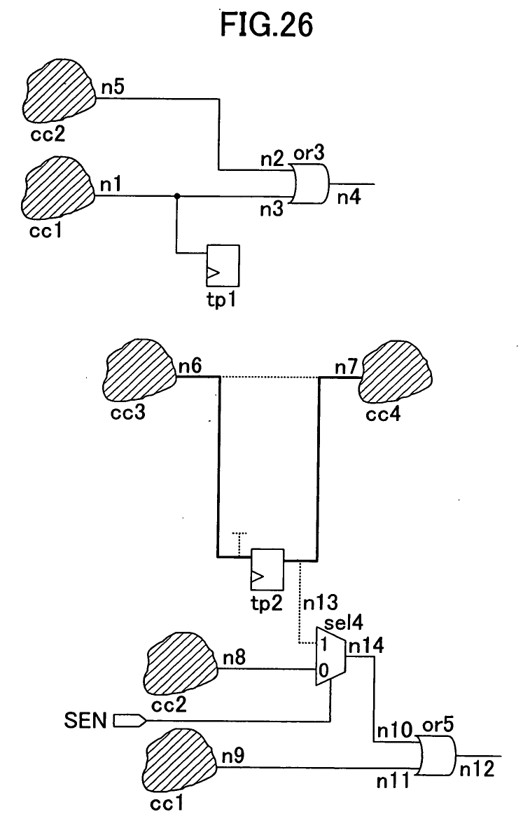

The steps of the flowchart of FIG. 24 are specifically described with reference to the layout image diagrams of a semiconductor integrated circuit shown in FIG. 25 and FIG. 26.

In the combinational circuit group of FIG. 25 (see upper part), an OR circuit or3 has an output node n4 and input nodes n2 and n3. The input node n3 is connected to an output node n1 of a combinational circuit cc1. The input node n2 is connected to an output node n5 of a combinational circuit cc2. In the combinational circuit group of FIG. 25 (see lower part), an OR circuit or5 has an output node n12 and input nodes n10 and n11. The input node n10 is connected to an output node n14 of a selector sel4. The input node n11 is connected to an output node n9 of the combinational circuit cc1. One of the input nodes of the selector sel4 is connected to an input node n8 of the combinational circuit cc2.

In scan test, the output node n5 of the combinational circuit cc2 is fixed to 1, or the value of the output node n8 of the combinational circuit cc2 is fixed. Therefore, at test point insertion step S503, an observation test point tp1 is inserted to be connected to the output node n1 of the combinational circuit cc1, and a control test point tp2 is inserted to be connected to the input node n13 of the selector sel4. At test point insertion step S503, the connection node names, instance names, and cell names of the observation test point tp1 and the control test point tp2, {n1, tp1, FF1} and {n13, tp2, FF1}, are output as additional register information S507.

Then, cells are placed at placement step S504, and the coordinate information of the observation test point tp1 and the control test point tp2 are added to additional register information S507.

Now, consider a case where it is necessary to modify the circuit such that a register is added between the combinational circuit cc3 and the combinational circuit cc4 as illustrated in embodiment 5. At ECO modification step S506, the data output connection from the node n13 to the control test point tp2 is disconnected based on additional register information S507 stored in a memory 702 and restriction S601 requiring that only a control test point be usable for a register, whereby the output node n6 and the input node n7 are disconnected as shown in FIG. 26. Then, the output node n6 is connected to the data input of the control test point tp2, and the input node n7 is connected to the data output of the control test point tp2.

In this embodiment, restriction S601 requiring that only a control test point be usable for a register is placed at ECO modification step S506. With restriction S601, the fault detection rate is improved with the control test point tp2 as compared with a case where the observation test point tp1 is used for a register.

As described above, the present invention is useful for a test point insertion method which is used for improving the fault detection rate in scan test of a semiconductor integrated circuit.

What is claimed is:

1. A method for inserting a test point to enable fault detection in a circuit which is disabled by propagation of a fixed value of a scan mode signal in scan design of a semiconductor integrated circuit, the method comprising the steps of:
(a) determining whether or not a value-fixed node needs value fixation;
(b) determining that an observation test point is to be inserted to a node which is disabled by the node determined to need value fixation at step (a), the observation test point allowing the disabled node to be observable;
(c) comparing a test efficiency achieved when a control test point is inserted to the node which is determined to need no value fixation at step (a) to allow the node to be controllable and a test efficiency achieved when an observation test point is inserted to a node which is disabled by the node determined to need no value fixation at step (a) to allow the disabled node to be observable;
(d) selecting one of the control test point and the observation test point which achieves the higher test efficiency based on the comparison result of step (c) and determining a node to which the selected test point is to be inserted; and
(e) inserting the selected test point to the node determined at step (d),
wherein the processes from step (a) to step (d) are repeatedly performed on nodes till the fault detection rate reaches a target value and, if the fault detection rate reaches the target value, the process of step (e) is performed.

2. The method of claim 1, wherein step (a) includes determining whether or not a value-fixed node needs value fixation according to scan test node fixation information which is information about a node needing value fixation in scan test.

3. The method of claim 2, further comprising:
the step of obtaining a result of propagation of a fixed value based on information about an input terminal whose value is fixed in scan test;
the step of determining, based on information about a node which necessarily needs to be fixed in scan test, a node included in an input cone of the necessarily-fixed node; and
the step of selecting, based on the result of propagation of a fixed value, information about the node included in the input cone as the scan test node fixation information.

4. The method of claim 1, wherein step (a) includes:
determining, based on information about a node which necessarily needs to be fixed in scan test, a node included in an input cone of the necessarily-fixed node;
if the value-fixed node is included in the input cone, determining that the value-fixed node needs value fixation; and
if the value-fixed node is not included in the input cone, determining that the value-fixed node does not need value fixation.

5. A test point insertion method, comprising the steps of:
(a) inserting a test point to enable fault detection in a circuit which is disabled by propagation of a fixed value of a scan mode signal in scan design of a semiconductor integrated circuit;
(b) placing cells after step (a); and
(c) consolidating consolidatable test points after step (b).

6. The method of claim 5, wherein:
a test point consolidation condition that test points are determined to be consolidatable if a linear distance between nodes to which the test points are inserted is equal to or shorter than a designated distance is established; and
step (c) includes determining whether or not test points are consolidatable based on the test point consolidation condition.

7. The method of claim 5, wherein:
a test point consolidation condition that test points are determined to be consolidatable if a Manhattan distance between nodes to which the test points are inserted is equal to or shorter than a designated distance is established; and
step (c) includes determining whether or not test points are consolidatable based on the test point consolidation condition.

8. The method of claim 5, wherein:
a test point consolidation condition that test points are determined to be consolidatable if a routing congestion degree between nodes to which the test points are inserted is equal to or lower than a designated routing congestion degree is established; and
step (c) includes determining whether or not test points are consolidatable based on the test point consolidation condition.

9. The method of claim 8, wherein the designated routing congestion degree is determined according to the number of lines within a unit area which are used for routing estimation in cell placement.

10. A test point insertion method, comprising the steps of:
(a) determining a node for insertion of a test point which enables fault detection in a circuit disabled by propagation of a fixed value of a scan mode signal in scan design of a semiconductor integrated circuit;
(b) placing cells after step (a);
(c) placing test points in a distributed fashion in an area where a congestion degree of the cells placed at step (b) and lines is lower than a predetermined reference value; and
(d) connecting the node determined for test point insertion at step (a) and the test point placed at step (c).

11. The method of claim 10, wherein:
step (a) includes outputting information about the node determined for test point insertion;
step (b) includes outputting critical path information; and
step (d) includes connecting the node and the test point based on the information about the node determined for test point insertion and the critical path information.

12. A test point insertion method, comprising the steps of:
(a) determining a node for insertion of a test point which enables fault detection in a circuit disabled by propagation of a fixed value of a scan mode signal in scan design of a semiconductor integrated circuit, the determined node including a node to which a control test point is to be inserted;
(b) inserting, to the node to which a control test point is to be inserted, a logic circuit which is necessary for insertion of a control test point;
(c) placing cells after step (b);
(d) placing test points in a distributed fashion in an area where a congestion degree of the cells placed at step (c) and lines is lower than a predetermined reference value; and
(e) connecting the control test point placed at step (d) to a terminal of the logic circuit inserted at step (b).

13. The method of claim 12, wherein:
step (a) includes outputting information about the node determined for test point insertion;
step (c) includes outputting critical path information; and
step (e) includes connecting the node and the test point based on the information about the node determined for test point insertion and the critical path information.

14. A test point insertion method, comprising the steps of:
(a) inserting a test point to enable fault detection in a circuit which is disabled by propagation of a fixed value of a scan mode signal in scan design of a semiconductor integrated circuit;
(b) placing cells after step (a); and
(c) if necessity of changing circuit specifications or modifying the circuit occurs after step (b), modifying the circuit using a test point as a repair cell.

15. The method of claim 14, wherein:
step (a) includes outputting information about the test point inserted to the node as additional register information;
step (b) includes adding coordinate information of the test point to the additional register information; and
step (c) includes modifying the circuit based on the additional register information.

16. The method of claim 15, wherein:
a restriction requiring that, among a control test point and an observation test point, only the control test point is usable as a repair cell is placed; and
step (c) includes modifying the circuit based on the restriction and the additional register information.
